(19) United States
(12) Patent Application Publication
(10) Pub. No.: US 2025/0392036 A1
(43) Pub. Date: Dec. 25, 2025

(54) ANTENNA MODULE COMPRISING FLOATING RADIATORS IN COMMUNICATION SYSTEM, AND ELECTRONIC DEVICE COMPRISING SAME

(71) Applicant: Samsung Electronics Co., Ltd., Suwon-si (KR)

(72) Inventors: Jungi JEONG, Suwon-si (KR); Hyunjin KIM, Suwon-si (KR); Bumhee LEE, Suwon-si (KR); Seungtae KO, Suwon-si (KR); Youngju LEE, Suwon-si (KR)

(21) Appl. No.: 19/307,833

(22) Filed: Aug. 22, 2025

Related U.S. Application Data
(63) Continuation of application No. 17/863,857, filed on Jul. 13, 2022, now Pat. No. 12,401,114.
Application No. 17/863,857 is a continuation of application No. PCT/KR2021/000599, filed on Jan. 15, 2021.
(60) Provisional application No. 62/961,754, filed on Jan. 16, 2020.

(51) Int. Cl. H01Q 1/24; H01Q 1/52; H01Q 5/385; H01Q 5/392; H01Q 19/00; H01Q 21/06

(52) U.S. Cl. CPC H01Q 1/246; H01Q 1/523; H01Q 5/385; H01Q 5/392; H01Q 19/005; H01Q 21/065

(57) ABSTRACT

The disclosure relates to a communication technique for merging an IoT technology with a 5th Generation (5G) communication system for supporting a higher data transmission rate than a 4th Generation (4G) system, and a system therefor. The disclosure can be applied to intelligent services (for example, smart homes, smart buildings, smart cities, smart cars or connected cars, healthcare, digital education, retail, security- and safety-related services, and the like) on the basis of 5G communication technologies and IoT-related technologies. An electronic device is provided. The electronic device includes a board, a plurality of antenna arrays arranged on the board, and a plurality of floating radiator arrays arranged on the board to be spaced apart from the plurality of antenna arrays by a predetermined distance. The plurality of floating radiator arrays are electromagnetically coupled to the plurality of antenna arrays.

### CROSS-REFERENCE TO RELATED APPLICATION(S)

This application is a continuation application of prior application Ser. No. 17/863,857, filed on Jul. 13, 2022, which is a continuation application, claiming priority under 35 U.S.C. § 365 (c), of an International application No. PCT/KR2021/000599, filed on Jan. 15, 2021, which is based on and claims the benefit of a U.S. Provisional application Ser. No. 62/961,754, filed on Jan. 16, 2020, in the U.S. Patent and Trademark Office, the disclosure of which is incorporated by reference herein in its entirety.

### BACKGROUND

### 1. Field

The disclosure relates to a communication system. More particularly, the disclosure relates to an antenna module including multiple floating radiators, and an electronic device including the same.

### 2. Description of Related Art

To meet the demand for wireless data traffic having increased since deployment of 4th-Generation (4G) communication systems, efforts have been made to develop an improved 5th-Generation (5G) or pre-5G communication system. Therefore, the 5G or pre-5G communication system is also called a ‘Beyond 4G Network’ or a ‘Post Long Term Evolution (LTE) System’. The 5G communication system is considered to be implemented in higher frequency (mmWave) bands, e.g., 60 GHZ bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like. In the 5G system, Hybrid Frequency Shift Keying (FSK) and Quadrature Amplitude Modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies, such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an antenna module structure for improving the side ratio and rear ratio of an antenna module of an electronic device in a communication system.

Another aspect of the disclosure is to provide an antenna module structure for improving the directivity of a beam radiated from an antenna module.

Another aspect of the disclosure is to provide an antenna module structure having a wide aperture for improving the directivity of a beam radiated from an antenna module.

Another aspect of the disclosure is to provide an antenna module structure for reducing surface waves of electromagnetic waves radiated from an antenna module.

Additional aspects will be set forth in part in the description which follows and, in part, will be apparent from the description, or may be learned by practice of the presented embodiments.

In accordance with an aspect of the disclosure, an electronic device is provided. The electronic device includes a board, a plurality of antenna arrays arranged on the board, and a plurality of floating radiator arrays arranged to be spaced apart from the plurality of antenna arrays by a predetermined distance on the board. The plurality of floating radiator arrays are electromagnetically coupled to the plurality of antenna arrays.

A first floating radiator array among the plurality of floating radiator arrays may be disposed to be spaced apart from a first side of a first antenna array among the plurality of antenna arrays by a predetermined distance.

A second floating radiator array among the plurality of floating radiator arrays may be disposed to be spaced apart from a second side of the first antenna array among the plurality of antenna arrays by a predetermined distance.

The second floating radiator array may be disposed to be spaced apart from a first side of a second antenna array among the plurality of antenna arrays by a predetermined distance.

Each of the plurality of floating radiator arrays may include a plurality of floating radiators.

Each of the plurality of floating radiators may have a ring shape.

The ring shape may include at least one of a rectangular ring shape, a circular ring shape, and a diamond-shaped ring shape.

Each of the plurality of floating radiators may include a capacitor and first to fourth inductors.

A factor value of each of the capacitor and the first to fourth inductors may be determined according to at least one of a horizontal length, a vertical length, a thickness, and a line width of each of the plurality of floating radiators.

A first end of the first inductor may be electrically connected to a second end of the fourth inductor.

A second end of the first inductor may be electrically connected to a first end of the second inductor.

A second end of the second inductor may be electrically connected to a first end of the third inductor.

A third end of the second inductor may be electrically connected to a first end of the capacitor.

A second end of the third inductor may be electrically connected to the second end of the fourth inductor.

A third end of the fourth inductor may be electrically connected to a second end of the capacitor.

Each of the plurality of floating radiators may be a patch-type radiator.

The patch-type radiator may have at least one shape of a diamond shape and a rectangular patch shape.

The electronic device further includes a feeding circuit configured to supply an electrical signal to the plurality of antenna arrays. The plurality of antenna arrays may radiate a first electromagnetic wave, based on the electrical signal. The plurality of floating radiator arrays may be electromagnetically coupled to the plurality of antenna arrays, based on the first electromagnetic wave, so as to radiate a second electromagnetic wave.

A phase of the first electromagnetic wave may correspond to a phase of the second electromagnetic wave.

The phase of the first electromagnetic wave and the phase of the second electromagnetic wave may be determined according to at least one of a horizontal length, a vertical length, a thickness, and a line width of each of the plurality of floating radiators.

An electronic device according to the disclosure may improve communication performance by improving the side ratio and rear ratio of an antenna module.

An electronic device according to the disclosure may improve the directivity of a beam radiated from an antenna module.

An electronic device according to the disclosure may improve the directivity of a beam radiated from an antenna module by increasing the area of an aperture for radiating beams through multiple floating radiators.

An electronic device according to the disclosure may reduce surface waves of electromagnetic waves radiated from an antenna module.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to an embodiment of the disclosure;

FIG. 2 is a graph illustrating antenna gain of an antenna module of the electronic device 10, according to an embodiment of the disclosure;

FIG. 3 is a top view of an antenna module of an electronic device, according to an embodiment of the disclosure;

FIG. 4 is a side view of an antenna module of an electronic device, according to an embodiment of the disclosure;

FIG. 5 is a top view of an antenna module of an electronic device, according to an embodiment of the disclosure;

FIG. 6 is a side view of an antenna module of an electronic device, according to an embodiment of the disclosure;

FIG. 7 is a conceptual diagram illustrating a flow of a current in an antenna module of an electronic device, according to an embodiment of the disclosure;

FIG. 8 is a conceptual diagram illustrating the flow of a current in at least one floating radiator among a plurality of floating radiators of an antenna module of an electronic device, according to an embodiment of the disclosure;

FIG. 9 is a conceptual diagram illustrating at least one floating radiator among a plurality of floating radiators of an antenna module of an electronic device, according to an embodiment of the disclosure;

FIG. 10 is a conceptual diagram illustrating at least one floating radiator among a plurality of floating radiators of an antenna module of an electronic device, according to an embodiment of the disclosure;

FIG. 11 is a conceptual diagram illustrating at least one floating radiator among a plurality of floating radiators of an antenna module of an electronic device, according to an embodiment of the disclosure;

FIG. 12 is a conceptual diagram illustrating at least one floating radiator among a plurality of floating radiators of an antenna module of an electronic device, according to an embodiment of the disclosure;

FIG. 13 is a conceptual diagram illustrating at least one floating radiator among a plurality of floating radiators of an antenna module of an electronic device, according to an embodiment of the disclosure;

FIG. 14 is a conceptual diagram illustrating radiation characteristics of an antenna module of an electronic device which does not include a plurality of floating radiators, according to an embodiment of the disclosure; and

FIG. 15 is a conceptual diagram illustrating radiation characteristics of an antenna module of an electronic device which includes a plurality of floating radiators, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, terms for identifying communication nodes or access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

In the following description, the disclosure will be described using terms and names defined in the 5GS and NR standard, which is the latest standard specified by the 3rd generation partnership project (3GPP) group among the existing communication standards, for the convenience of description. However, the disclosure is not limited by these terms and names, and may be applied in the same way to systems that conform other standards. In particular, the disclosure may be applied to 3GPP 5GS/NR (5th generation mobile communication standard).

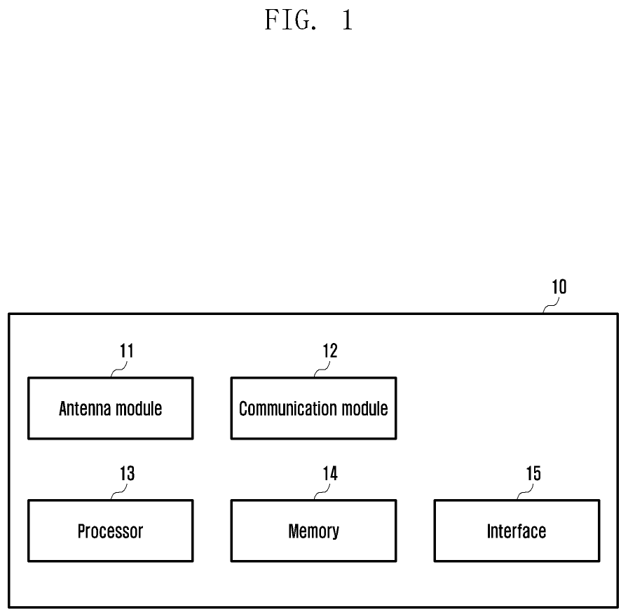

FIG. 1 is a block diagram illustrating an electronic device in a network environment according to an embodiment of the disclosure.

Referring to FIG. 1, an electronic device 10 in the network environment may communicate with any other electronic device (not shown) or a server (not shown) via a network (e.g., a wired or wireless communication network). For example, the electronic device 10 may be a base station and the other electronic device may be a terminal.

According to an embodiment, the electronic device 10 may include an antenna module 11, a communication module 12, a processor 13, a memory 14, and an interface 15. In some embodiments, at least one of the components may be omitted from the electronic device 10, or one or more other components may be added in the electronic device 10. In some embodiments, some of the components may be integrated into a single element.

The processor 13 may control, for example, at least one other component (e.g., a hardware or software component) of the electronic device 10, coupled with the processor 13, and may perform various data processing or computation. According to one embodiment, as at least part of the data processing or computation, the processor 13 may store a command or data received from another component (e.g., the communication module 12) in the memory 14, process the command or the data stored in the memory 14, and store resulting data in the memory 14.

The memory 14 may store various data used by at least one component of the electronic device 10. The data may include, for example, software and input data or output data for a command related thereto.

The interface 15 may support one or more specified protocols that may be used for the electronic device 10 to be coupled directly or wirelessly with any other electronic device. According to another embodiment, the interface 15 may include, for example, a universal serial bus (USB) interface or a secure digital (SD) card interface.

The communication module 12 may support establishing a wired communication channel or a wireless communication channel between the electronic device 10 and any other electronic device and performing communication via the established communication channel. The communication module 12 may include one or more communication processors that are operable independently from the processor 13 and supports a wired communication or a wireless communication. According to yet another embodiment, the communication module 12 may communicate with any other electronic device or a server via a legacy cellular network, a 5G network, a next-generation communication network, the Internet, or a computer network (e.g., LAN or WAN). These various types of communication modules may be implemented as a single component (e.g., a single chip), or may be implemented as multi components (e.g., multi chips) separate from each other.

The communication module 12 may supports 5G network and next-generation communication technologies beyond the 4G network, for example, new radio (NR) access technology. The NR access technology may support high-speed transmission of high-capacity data (enhanced mobile broadband (eMBB)), terminal power minimization and multi-terminal access (massive machine type communications (mMTC)), or ultra-reliable and low-latency communications (URLLC). For example, the communication module 12 may support ultrahigh frequency (mmWave) bands so as to accomplish higher data rates. The communication module 12 may support various techniques for ensuring performance in the ultrahigh frequency bands, such as beamforming, massive multiple-input multiple-output (massive MIMO), full dimensional MIMO (FD-MIMO), array antenna, analog beam forming, large scale antenna techniques. The communication module 12 support various requirements specified for the electronic device 10, any other electronic device, or a network system.

The antenna module 11 may transmit or receive a signal or power to or from the outside (e.g., any other electronic device) of the electronic device 10. According to yet another embodiment, the antenna module 11 may include an antenna including a radiating element composed of a conductive material or a conductive pattern formed on a substrate (e.g., PCB). According to yet another embodiment, the antenna module 11 may include a plurality of antennas. In such a case, at least one antenna appropriate for a communication scheme used in a network may be selected, for example, by the communication module 12 from the plurality of antennas. The signal or the power may then be transmitted or received between the communication module 12 and any other external electronic device via the selected at least one antenna. According to some embodiments, another component (e.g., a radio frequency integrated circuit (RFIC)) other than the radiating element may be additionally formed as part of the antenna module 11.

According to various embodiments, the antenna module 11 may form a mmWave antenna module. According to yet another embodiment, the mmWave antenna module may include a printed circuit board, a RFIC disposed at a first surface (e.g., the lower surface) of the printed circuit board or adjacent thereto and capable of supporting specified high-frequency bands (e.g., mmWave bands), and a plurality of antennas (e.g., an array antenna) disposed at a second surface (e.g., the upper or side surface) of the printed circuit board or adjacent thereto and capable of transmitting or receiving signals in the specified high-frequency bands.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to yet another embodiment, commands or data may be transmitted or received between the electronic device 10 and any other external electronic device via a server coupled with a network. The other external electronic device may be a device of a same type as, or a different type, from the electronic device 10. According to yet another embodiment, all or some of operations to be executed at the electronic device 10 may be executed at the other external electronic device. For example, if the electronic device 10 should perform a function or a service automatically, or in response to a request from a user or another device, the electronic device 10, instead of, or in addition to, executing the function or the service, may request one or more other external electronic devices to perform at least part of the function or the service. The one or more other external electronic devices receiving the request may perform the at least part of the function or the service requested, or an additional function or an additional service related to the request, and transfer an outcome of the performing to the electronic device 10. The electronic device 10 may provide the outcome, with or without further processing of the outcome, as at least part of a reply to the request. To that end, a cloud computing, distributed computing, mobile edge computing (MEC), or client-server computing technology may be used, for example. The electronic device 10 may provide, for example, an ultra-low-latency service using distributed computing or MEC. In other embodiments, the other external electronic devices may include Internet of things (IoT) devices.

The electronic device according to various embodiments disclosed herein may be one of various types of electronic devices. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to yet another embodiment, the “module” may be implemented in the form of an application-specific integrated circuit (ASIC).

Various embodiments as set forth herein may be implemented as software including one or more instructions that are stored in a storage medium (e.g., the memory 14) that is readable by a machine (e.g., the electronic device 10). For example, a processor (e.g., the processor 13) of the machine (e.g., the electronic device 10) may invoke at least one of the one or more stored instructions from the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to yet another embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements may be omitted, or one or more other elements may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

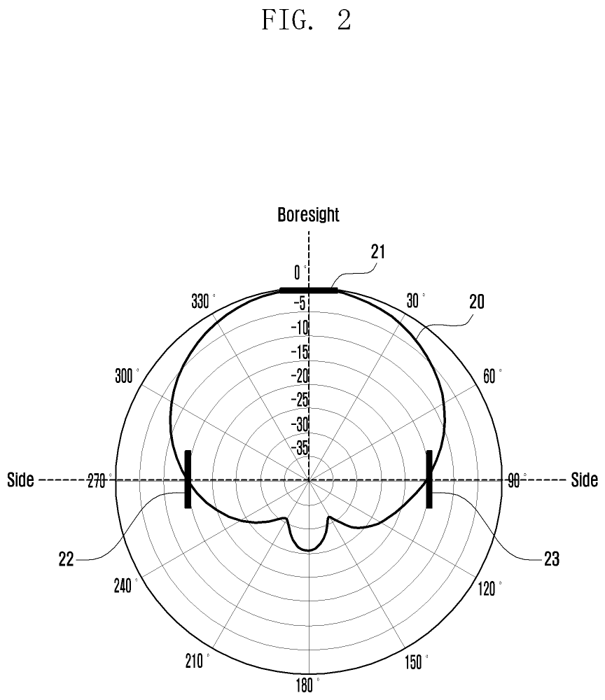

FIG. 2 is a graph illustrating antenna gain of an antenna module of an electronic device, according to an embodiment of the disclosure.

Referring to FIG. 2, in a graph 20 of antenna gain for an electromagnetic wave radiated from the antenna module 11 of the electronic device 10, a value 21 in a front direction and values 22 and 23 in a lateral direction may be different from each other. A side ratio of an antenna may be defined as a difference between an antenna gain value 21 with respect to the front direction and an antenna gain value 21 or 22 with respect to the lateral direction of the electromagnetic wave radiated from the antenna module 11.

For example, the antenna module 11 may include a plurality of antenna arrays. In this case, when the amount of electromagnetic waves radiated from one antenna array in the lateral direction is small, the influence on another antenna array positioned on a side surface of the one antenna array may be reduced. For example, when a side ratio for each of the plurality of antenna arrays of the antenna module 11 is reduced, the mutual influence of the plurality of antenna arrays may be reduced.

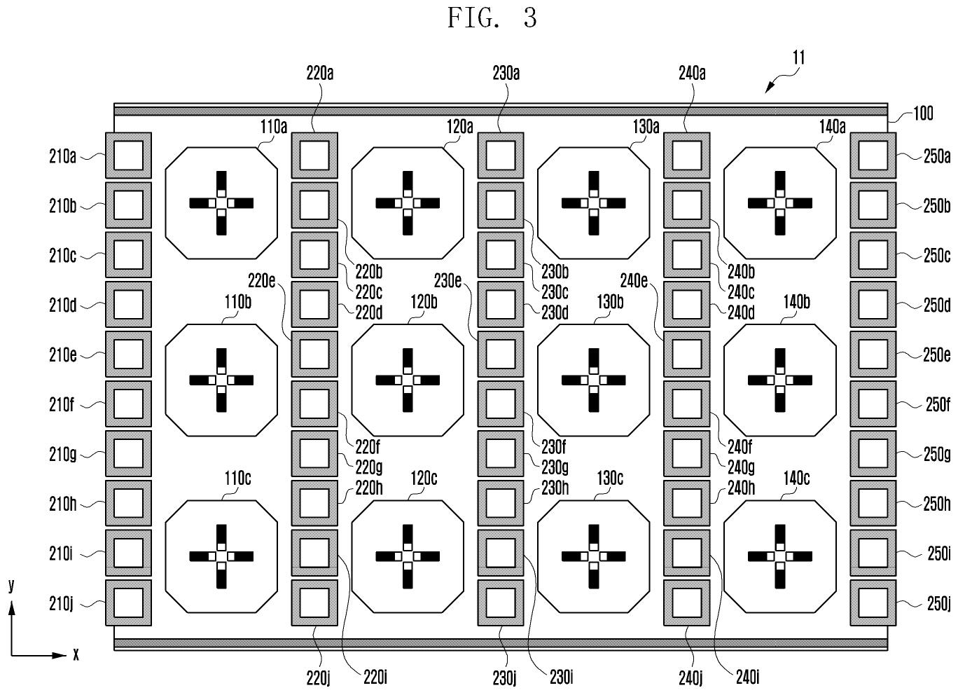

The antenna module 11 of the electronic device 10 according to various embodiments may have a structure which reduces a side ratio. For example, the structure of the antenna module 11 may be as shown in FIG. 3.

FIG. 3 is a top view of an antenna module of an electronic device 10, according to an embodiment of the disclosure.

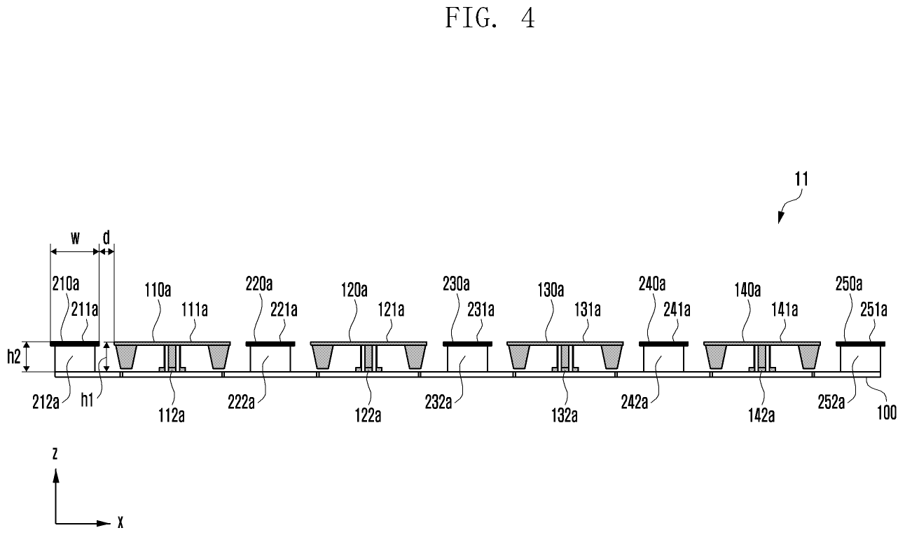

FIG. 4 is a side view of an antenna module of an electronic device, according to an embodiment of the disclosure.

Referring to FIGS. 3 and 4, the antenna module 11 may include a board 100, a plurality of antenna elements 110a to 140c, and a plurality of floating radiators 210a to 250c.

The plurality of antenna elements 110a-110c, 120a-120c, 130a-130c and 140a-140c may be disposed on an upper surface of the board 100. First antenna elements 110a to 110c may be disposed in a first column of the board 100. A 1a-th antenna element 110a may be disposed in a first row of the first column of the board 100. The 1a-th antenna element 110a may include a 1a-th body 111a and a 1a-th supporter 112a.

A 1b-th antenna element 110b may be disposed in a second row of the first column of the board 100. The 1b-th antenna element 110b may include a 1b-th body 111b and a 1b-th supporter 112b.

A 1c-th antenna element 110c may be disposed in a third row of the first column of the board 100. The 1c-th antenna element 110c may include a 1c-th body 111c and a 1c-th supporter 112c.

Second antenna elements 120a to 120c may be disposed in a second column of the board 100. A 2a-th antenna element 120a may be disposed in a first row of the second column of the board 100. The 2a-th antenna element 120a may include a 2a-th body 121a and a 2a-th supporter 122a.

A 2b-th antenna element 120b may be disposed in a second row of the second column of the board 100. The 2b-th antenna element 120b may include a 2b-th body 121b and a 2b-th supporter 122b.

A 2c-th antenna element 120c may be disposed in a third row of the second column of the board 100. The 2c-th antenna element 120c may include a 2c-th body 121c and a 2c-th supporter 122c.

Third antenna elements 130a to 130c may be disposed in a third column of the board 100. A 3a-th antenna element 130a may be disposed in a first row of the third column of the board 100. The 3a-th antenna element 130a may include a 3a-th body 131a and a 3a-th supporter 132a.

A 3b-th antenna element 130b may be disposed in a second row of the third column of the board 100. The 3b-th antenna element 130b may include a 3b-th body 131b and a 3b-th supporter 132b.

A 3c-th antenna element 130c may be disposed in a third row of the third column of the board 100. The 3c-th antenna element 130c may include a 3c-th body 131c and a 3c-th supporter 132c.

Fourth antenna elements 140a to 140c may be disposed in a fourth column of the board 100. A 4a-th antenna element 140a may be disposed in a first row of the fourth column of the board 100. The 4a-th antenna element 140a may include a 4a-th body 141a and a 4a-th supporter 142a.

A 4b-th antenna element 140b may be disposed in a second row of the fourth column of the board 100. The 4b-th antenna element 140b may include a 4b-th body 141b and a 4b-th supporter 142b.

A 4c-th antenna element 140c may be disposed in a third row of the fourth column of the board 100. The 4c-th antenna element 140c may include a 4c-th body 141c and a 4c-th supporter 142c.

A plurality of floating radiators 210a-210j, 220a-220j, 230a-230j, 240a-240j and 250a-250j may be disposed on the upper surface of the board 100. For example, first floating radiators 210a to 210j may be disposed on the left side of the first antenna elements 110a to 110c on the upper surface of the board 100. For example, the first floating radiators 210a to 210j may be spaced apart from the first antenna elements 110a to 110c by a predetermined distance.

Second floating radiators 220a to 220j may be disposed between the first antenna elements 110a to 110c and the second antenna elements 120a to 120c on the upper surface of the board 100. For example, the second floating radiators 220a to 220j may be disposed on the right side of the first antenna elements 110a to 110c. The second floating radiators 220a to 220j may be spaced apart from the first antenna elements 110a to 110c by a predetermined distance. The second floating radiators 220a to 220j may be disposed on the left side of the second antenna elements 120a to 120c. The second floating radiators 220a to 220j may be spaced apart from the second antenna elements 120a to 120c by a predetermined distance.

Third floating radiators 230a to 230j may be disposed between the second antenna elements 120a to 120c and the third antenna elements 130a to 130c on the upper surface of the board 100. For example, the third floating radiators 230a to 230j may be disposed on the right side of the second antenna elements 120a to 120c. The third floating radiators 230a to 230j may be spaced apart from the second antenna elements 120a to 120c by a predetermined distance. The third floating radiators 230a to 230j may be disposed on the left side of the third antenna elements 130a to 130c. The third floating radiators 230a to 230j may be spaced apart from the third antenna elements 130a to 130c by a predetermined distance.

Fourth floating radiators 240a to 240j may be disposed between the third antenna elements 130a to 130c and the fourth antenna elements 140a to 140c on the upper surface of the board 100. For example, the fourth floating radiators 240a to 240j may be disposed on the right side of the third antenna elements 130a to 130c. The fourth floating radiators 240a to 240j may be spaced apart from the third antenna elements 130a to 130c by a predetermined distance. The fourth floating radiators 240a to 240j may be disposed on the left side of the fourth antenna elements 140a to 140c. The fourth floating radiators 240a to 240j may be spaced apart from the fourth antenna elements 140a to 140c by a predetermined distance.

Fifth floating radiators 250a to 250j may be disposed on the left side of the fourth antenna elements 140a to 140c on the upper surface of the board 100. The fifth floating radiators 250a to 250j may be spaced apart from the fourth antenna elements 140a to 140c by a predetermined distance.

The directivity of a beam radiated from the antenna module 11 may be proportional to the width of an aperture of the antenna module 11 radiating the beam. For example, as the aperture of the antenna module 11 increases, the width of a beam radiated from the antenna module 11 may be reduced.

The antenna module 11 may increase the aperture of the antenna module 11 through the plurality of floating radiators 210a to 250c. That is, the antenna module 11 may reduce the width of a beam radiated from the antenna module 11 through the plurality of floating radiators 210a to 250c. Accordingly, the antenna module 11 may increase the directivity of a beam radiated from the antenna module 11 through the plurality of floating radiators 210a to 250c.

In addition, the antenna module 11 may reduce a surface wave caused by an electromagnetic wave radiated from the plurality of antenna elements 110a to 140c through the plurality of floating radiators 210a to 250c.

Referring to FIG. 4, an upper surface of the 1a-th antenna element 110a may be spaced apart from the upper surface of the board 100 by a predetermined distance h1. A 1a-th floating radiator 210a may be disposed to be spaced apart from the left side of the 1a-th antenna element 110a by a predetermined distance d on the board 100. An upper surface of the 1a-th floating radiator 210a may be spaced apart from the upper surface of the board 100 by a predetermined distance h2. A horizontal width w of the 1a-th floating radiator 210a may have a predetermined size.

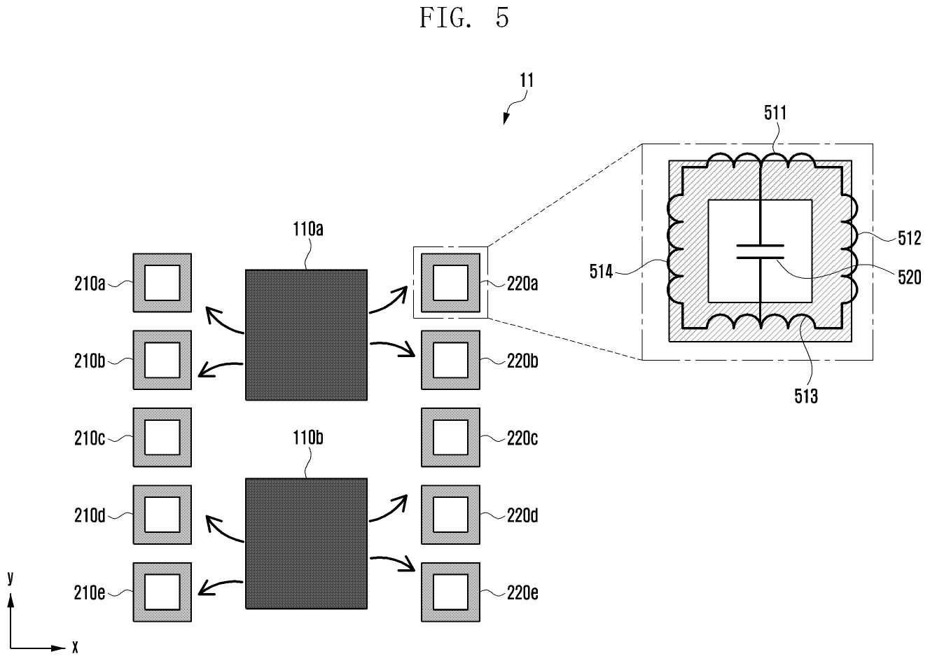

FIG. 5 is a top view of an antenna module of an electronic device, according to an embodiment of the disclosure.

Referring to FIG. 5, the plurality of floating radiators 210a to 210e and 220a to 220e of the antenna module 11 may be electromagnetically coupled to the plurality of antenna elements 110a to 110b.

For example, the plurality of antenna elements 110a to 110b may radiate a first electromagnetic wave. An electromagnetic field may be induced in the plurality of floating radiators 210a to 210e and 220a to 220e by the first electromagnetic wave radiated from the plurality of antenna elements 110a to 110b. For example, the plurality of floating radiators 210a to 210e and 220a to 220e may radiate a second electromagnetic wave due to the electromagnetic field induced by the first electromagnetic wave.

The antenna module 11 may have a wider aperture due to the plurality of floating radiators 210a to 210e and 220a to 220e. The antenna module 11 may radiate a beam, based on the first electromagnetic wave and the second electromagnetic wave. For example, the width of a beam radiated from the antenna module 11 may be narrowed by the first electromagnetic wave and the second electromagnetic wave.

The plurality of floating radiators 210a to 210e and 220a to 220e may prevent the first electromagnetic wave radiated from the plurality of antenna elements 110a to 110b from propagating to the surface of the antenna module 11. For example, the plurality of floating radiators 210a to 210e and 220a to 220e may reduce the influence of a surface wave caused by the first electromagnetic wave.

The plurality of floating radiators 210a to 210e and 220a to 220e may have a capacitance factor and an inductance factor. For example, a 2a-th floating radiator 220a may have a plurality of inductance factors and a capacitance factor. For example, an inductance factor may be referred to as an inductor. A capacitance factor may be referred to as a capacitor. For example, the 2a-th floating radiator 220a may include a plurality of inductors 511 to 514 and a capacitor 520. A first end of a first inductor 511 may be electrically connected to a first end of a fourth inductor 514. A second end of the first inductor 511 may be electrically connected to a first end of a second inductor 512. A second end of the second inductor 512 may be electrically connected to a first end of a third inductor 513. A second end of the third inductor 513 may be electrically connected to the first end of the fourth inductor 514. One end of the capacitor 520 may be electrically connected to a third end of the first inductor 511. One end of the capacitor 520 may be electrically connected to a third end of the third inductor 513.

A capacitance factor and an inductance factor of each of the plurality of floating radiators 210a to 210e and 220a to 220e may be determined according to at least one of a horizontal length, a vertical length, a thickness, and a line width of each of the plurality of floating radiators 210a to 210e and 220a to 220e. For example, a factor value of each of a plurality of inductors 511 to 514 and a capacitor 520 may be determined according to at least one of a horizontal length, a vertical length, a thickness, and a line width of the 2a-th floating radiator 220a. For example, an imaginary component of the factor value of each of the plurality of inductors 511 to 514 and the capacitor 520 may be determined according to at least one of the horizontal length, the vertical length, the thickness, and the line width of the 2a-th floating radiator 220a. For example, an imaginary component of an inductance value of each of the plurality of inductors 511 to 514 and an imaginary component of a capacitance value of the capacitor 520 may be determined according to at least one of the horizontal length, the vertical length, the thickness, and the line width of the 2a-th floating radiator 220a.

A phase of a second electromagnetic wave radiated from the 2a-th floating radiator 220a may be determined based on the imaginary component of the factor value of each of the plurality of inductors 511 to 514 and the capacitor 520. That is, the phase of the second electromagnetic wave radiated from the 2a-th floating radiator 220a may be determined based on at least one of the horizontal length, the vertical length, the thickness, and the line width of the 2a-th floating radiator 220a. At least one of the horizontal length, the vertical length, the thickness, and the line width of the 2a-th floating radiator 220a may be determined such that a phase of a second electromagnetic wave is the same as a phase of a first electromagnetic wave.

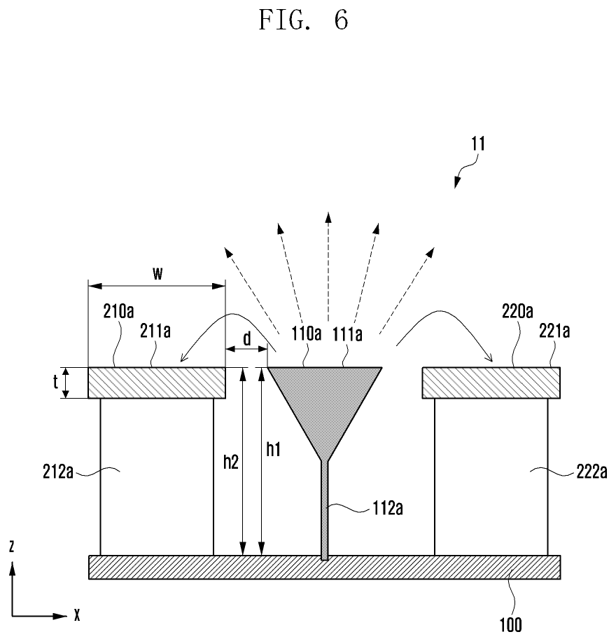

FIG. 6 is a side view of an antenna module of an electronic device, according to an embodiment of the disclosure.

Referring to FIG. 6, an upper surface of the body 111a of the 1a-th antenna element 110a of the antenna module 11 may be spaced apart from the upper surface of the board 100 by a predetermined distance h1.

The 1a-th floating radiator 210a may include a 1a-th body 211a and a 1a-th supporter 212a. For example, the 1a-th supporter 212a may be disposed on the upper surface of the board 100. Alternatively, the 1a-th supporter 212a may be integrally injected with the board 100.

The 1a-th body 211a may be disposed on an upper surface of the 1a-th supporter 212a. The 1a-th body 211a may be disposed to be spaced apart from the left side of the 1a-th antenna element 110a by a predetermined distance d on the board 100. An upper surface of the 1a-th body 211a may be spaced apart from the upper surface of the board 100 by a predetermined distance h2.

A factor value of each of the plurality of inductors 511 to 514 and the capacitor 520 of FIG. 5 may be determined based on a thickness t and a length w of a horizontal or vertical width of the 1a-th body 211a. For example, an imaginary component of the factor value of each of the plurality of inductors 511 to 514 and the capacitor 520 may be determined according to at least one of the thickness t and the length w of the horizontal or vertical width of the 1a-th body 211a. For example, an imaginary component of an inductance value of each of the plurality of inductors 511 to 514 and an imaginary component of a capacitance value of the capacitor 520 may be determined according to at least one of the thickness t and the length w of the horizontal or vertical width of the 1a-th body 211a.

A direction of a second electromagnetic wave radiated from the 1a-th floating radiator 210a may be determined based on the imaginary component of the factor value of each of the plurality of inductors 511 to 514 and the capacitor 520 of FIG. 5. That is, a phase of the second electromagnetic wave radiated from the 1a-th floating radiator 210a may be determined based on at least one of the thickness t and the length w of the horizontal or vertical width of the 1a-th body 211a. At least one of the thickness t and the length w of the horizontal or vertical width of the 1a-th body 211a may be determined such that a phase of a second electromagnetic wave is the same as a radiation direction of a first electromagnetic wave.

The 2a-th floating radiator 220a may include a 2a-th body 221a and a 2a-th supporter 222a. For example, the 2a-th supporter 222a may be disposed on the upper surface of the board 100. Alternatively, the 2a-th supporter 222a may be integrally injected with the board 100.

The 2a-th body 221a may be disposed on an upper surface of the 2a-th supporter 222a. The 2a-th body 221a may be disposed to be spaced apart from the right side of the 1a-th antenna element 110a by a predetermined distance d on the board 100. An upper surface of the 2a-th body 221a may be spaced apart from the upper surface of the board 100 by a predetermined distance.

A distance h1 from the upper surface of the board 100 to the upper surface of the body 111a of the 1a-th antenna element 110a, a distance h2 from the upper surface of the board 100 to the upper surface of the 1a-th body 211a of the 1a-th floating radiator 210a, and a distance from the upper surface of the board 100 to the upper surface of the 2a-th body 221a of the 2a-th floating radiator 220a may be the same or similar. Alternatively, the distance h1 from the upper surface of the board 100 to the upper surface of the body 111a of the 1a-th antenna element 110a, the distance h2 from the upper surface of the board 100 to the upper surface of the 1a-th body 211a of the 1a-th floating radiator 210a, and the distance from the upper surface of the board 100 to the upper surface of the 2a-th body 221a of the 2a-th floating radiator 220a may be different from each other.

The 1a-th antenna element 110a may radiate a first electromagnetic wave. For example, the first electromagnetic wave may be radiated from the 1a-th antenna element 110a on an x-axis, a y-axis, and a z-axis. A component radiated on the x-axis from the first electromagnetic wave may induce an electromagnetic field in the 1a-th floating radiator 210a and the 2a-th floating radiator 220a. For example, the 1a-th floating radiator 210a may re-radiate an electromagnetic wave, based on the first electromagnetic wave. In addition, the 2a-th floating radiator 220a may re-radiate an electromagnetic wave, based on the first electromagnetic wave.

For example, an electromagnetic field may be induced in the 1a-th floating radiator 210a by the first electromagnetic wave radiated from the 1a-th antenna element 110a. The 1a-th floating radiator 210a may radiate a second electromagnetic wave by the induced electromagnetic field.

An electromagnetic field may be induced in the 2a-th floating radiator 220a by the first electromagnetic wave radiated from the 1a-th antenna element 110a. The 2a-th floating radiator 220a may radiate a second electromagnetic wave by the induced electromagnetic field.

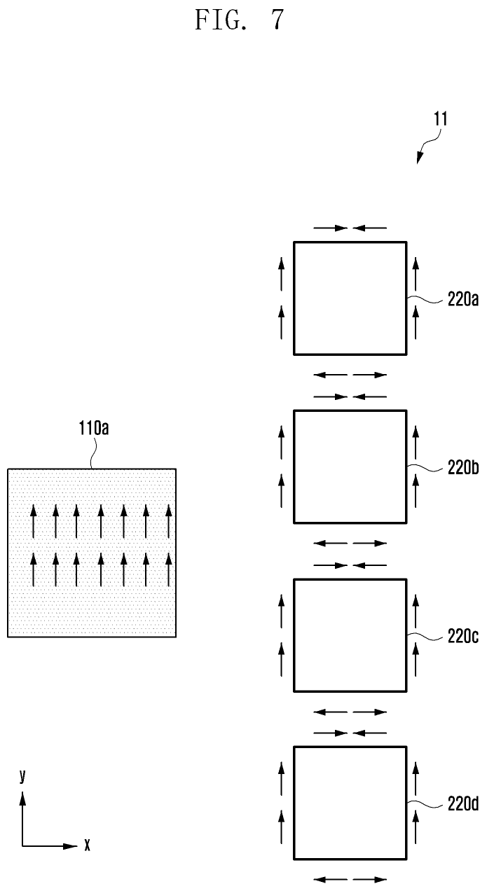

FIG. 7 is a conceptual diagram illustrating the flow of a current in the antenna module 11 of the electronic device 10, according to an embodiment of the disclosure.

Referring to FIG. 7, in the antenna module 11, the plurality of floating radiators 220a to 220d may be electromagnetically coupled to the 1a-th antenna element 110a.

For example, an electromagnetic field may be induced in each of the plurality of floating radiators 220a to 220d by a first electromagnetic wave radiated from the 1a-th antenna element 110a. Each of the plurality of floating radiators 220a to 220d in which the electromagnetic field is induced by the first electromagnetic wave may radiate a second electromagnetic wave by the electromagnetic field.

For example, the 1a-th floating radiator 220a may radiate a second electromagnetic wave by an electromagnetic field induced from the 1a-th antenna element 110a. A 1b-th floating radiator 220b may radiate a second electromagnetic wave by the electromagnetic field induced from the 1a-th antenna element 110a. A 1c-th floating radiator 220c may radiate a second electromagnetic wave by the electromagnetic field induced from the 1a-th antenna element 110a. A 1d-th floating radiator 220d may radiate a second electromagnetic wave by the electromagnetic field induced from the 1a-th antenna element 110a.

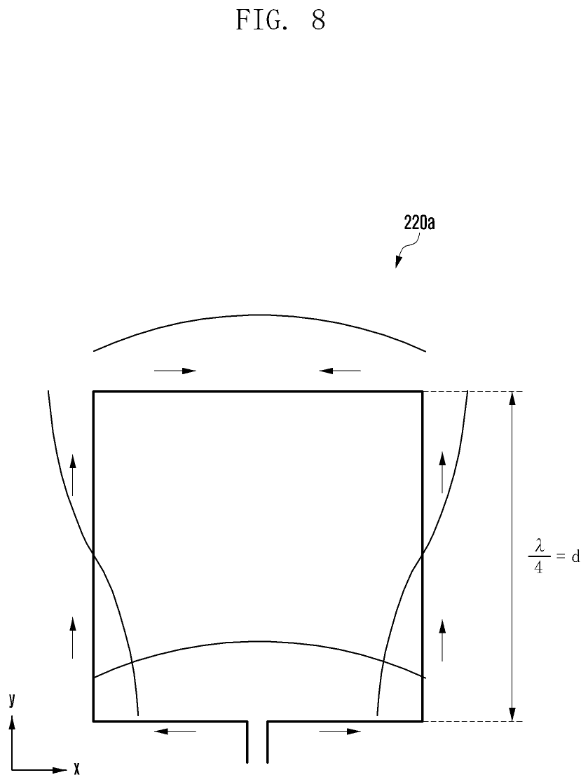

FIG. 8 is a conceptual diagram illustrating the flow of a current in at least one floating radiator among a plurality of floating radiators of an antenna module of an electronic device, according to an embodiment of the disclosure.

Referring to FIG. 8, at least one floating radiator among the plurality of floating radiators 210a to 250c may be designed in a wavelength loop manner. For example, the 2a-th floating radiator 220a may be designed in the wavelength loop manner. The 2a-th floating radiator 220a designed in the wavelength loop manner may operate as a radiator.

For example, a horizontal or vertical length d of the 2a-th floating radiator 220a may be determined based on a length 2 of wavelength of a first electromagnetic wave radiated from the 1a-th antenna element 110a. For example, the horizontal or vertical length d of the 2a-th floating radiator 220a may be ¼ of the length λ of the wavelength of the first electromagnetic wave radiated from the 1a-th antenna element 110a. For example, a total length d*4 of the 2a-th floating radiator 220a may be the same as the length 2 of the wavelength of the first electromagnetic wave radiated from the 1a-th antenna element 110a.

For example, the polarization of the first electromagnetic wave radiated from the 1a-th antenna element 110a may be in a z-axis direction or close to the z-axis direction with reference to the upper surface of the 1a-th antenna element 110a. In this case, a horizontal component of a current in an electromagnetic field induced in the 2a-th floating radiator 220a having a horizontal or vertical length of λ/4 may be extinguished by mutual interference between upper and lower surfaces of the 2a-th floating radiator 220a. Therefore, in the electromagnetic field induced in the 2a-th floating radiator 220a, the horizontal component of the current may be extinguished and only a vertical component may exist.

For example, a direction of a current of the 1a-th antenna element 110a may be the same as or similar to a direction of a current flowing through the 2a-th floating radiator 220a. For example, the antenna module 11 may have a wider aperture due to the plurality of floating radiators 210a to 250c and the plurality of antenna elements 110a to 140c having the same or similar current direction.

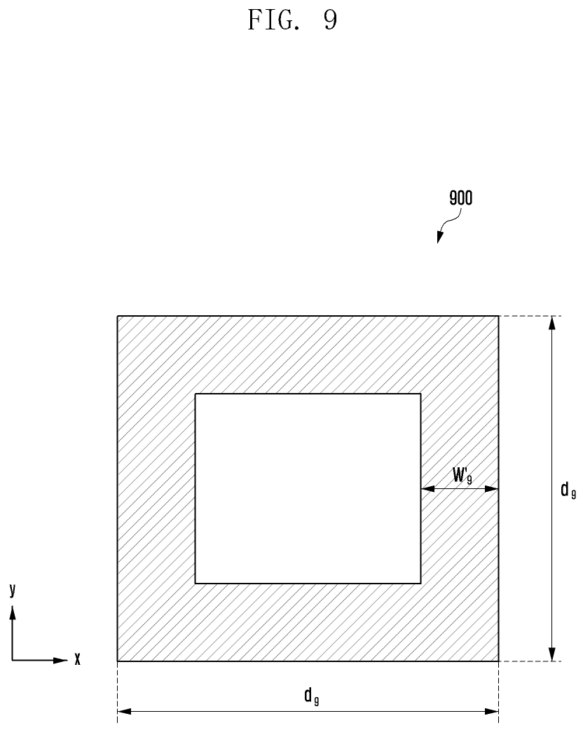

A shape and size of each of the plurality of floating radiators 210a to 250j may be the same as or similar to a shape and size of at least one of the floating radiators of FIGS. 9 to 13.

FIG. 9 is a conceptual diagram illustrating at least one floating radiator among a plurality of floating radiators of an antenna module of an electronic device, according to an embodiment of the disclosure.

Referring to FIG. 9, a floating radiator 900 may have a rectangular ring shape. The floating radiator 400 may be the same as or similar to at least one of the plurality of floating radiators 210a to 250j of FIG. 3.

For example, a horizontal length w9, a vertical length d9, and a line width w′9 of the floating radiator 900 may be determined based on the magnitude of wavelength of an electromagnetic field output from the plurality of antenna elements 110a to 140c of FIG. 3.

A factor value of each of the plurality of inductors 511 to 514 and the capacitor 520 of FIG. 5 may be determined according to at least one of the horizontal length w9, the vertical length d9, and the line width w′9 of the floating radiator 900. For example, an imaginary component of the factor value of each of the plurality of inductors 511 to 514 and the capacitor 520 may be determined according to at least one of the horizontal length w9, the vertical length d9, and the line width w′9 of the floating radiator 900. For example, an imaginary component of an inductance value of each of the plurality of inductors 511 to 514 and an imaginary component of a capacitance value of the capacitor 520 may be determined according to at least one of the horizontal length w9, the vertical length d9, and the line width w′9 of the floating radiator 900.

A direction of a second electromagnetic wave radiated from the floating radiator 900 may be determined based on the imaginary component of the factor value of each of the plurality of inductors 511 to 514 and the capacitor 520 of FIG. 5. For example, the direction of the second electromagnetic wave radiated from the floating radiator 900 may be determined based on at least one of the horizontal length w9, the vertical length d9, and the line width w′9 of the floating radiator 900. At least one of the horizontal length w9, the vertical length d9, and the line width w′9 of the floating radiator 900 may be determined such that a radiation direction of a second electromagnetic wave radiated from the floating radiator 900 is the same as a radiation direction of a first electromagnetic wave radiated from the 1a-th antenna element 110a.

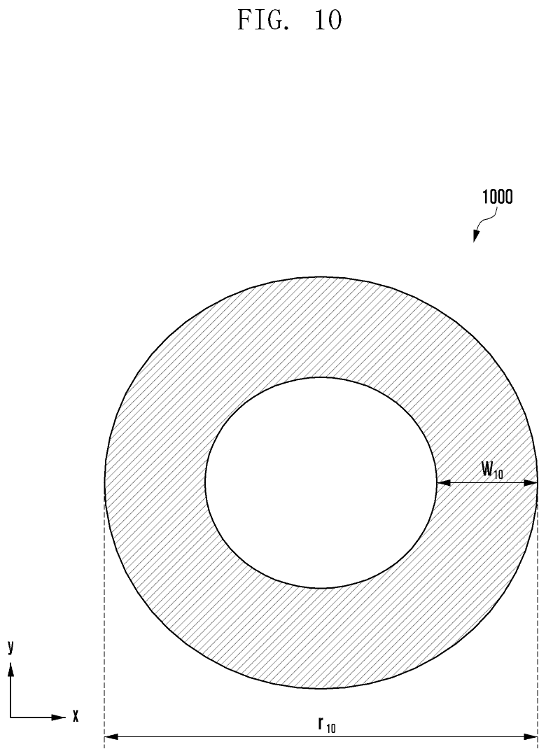

FIG. 10 is a conceptual diagram illustrating at least one floating radiator among a plurality of floating radiators of an antenna module of an electronic device, according to an embodiment of the disclosure.

Referring to FIG. 10, a floating radiator 1000 may have a circular ring shape. The floating radiator 1000 may be the same as or similar to at least one of the plurality of floating radiators 210a to 250j of FIG. 3.

For example, a line width w10 and a length d10 of a diameter of the floating radiator 1000 may be determined based on the magnitude of wavelength of an electromagnetic field output from the plurality of antenna elements 110a to 140c of FIG. 3.

A factor value of each of the plurality of inductors 511 to 514 and the capacitor 520 of FIG. 5 may be determined according to at least one of the line width w10 and the length d10 of the diameter of the floating radiator 1000. For example, an imaginary component of the factor value of each of the plurality of inductors 511 to 514 and the capacitor 520 may be determined according to at least one of the line width w10 and the length d10 of the diameter of the floating radiator 1000. For example, an imaginary component of an inductance value of each of the plurality of inductors 511 to 514 and an imaginary component of a capacitance value of the capacitor 520 may be determined according to at least one of the line width w10 and the length d10 of the diameter of the floating radiator 1000.

A direction of a second electromagnetic wave radiated from the floating radiator 1000 may be determined based on the imaginary component of the factor value of each of the plurality of inductors 511 to 514 and the capacitor 520 of FIG. 5. For example, the direction of the second electromagnetic wave radiated from the floating radiator 1000 may be determined based on at least one of the line width w10 and the length d10 of the diameter of the floating radiator 1000. At least one of the line width w10 and the length d10 of the diameter of the floating radiator 1000 may be determined such that a radiation direction of a second electromagnetic wave radiated from the floating radiator 1000 is the same as a radiation direction of a first electromagnetic wave radiated from the 1a-th antenna element 110a.

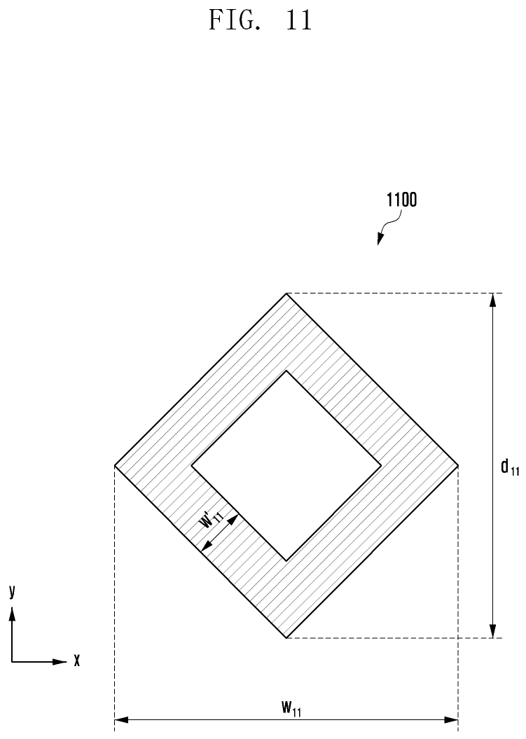

FIG. 11 is a conceptual diagram illustrating at least one floating radiator among a plurality of floating radiators of an antenna module of an electronic device, according to an embodiment of the disclosure.

Referring to FIG. 11, a floating radiator 1100 may have a diamond-shaped ring shape. The floating radiator 1100 may be the same as or similar to at least one of the plurality of floating radiators 210a to 250j of FIG. 3.

For example, a horizontal length w11, a vertical length d11, and a line width w′11 of the floating radiator 1100 may be determined based on the magnitude of wavelength of an electromagnetic field output from the plurality of antenna elements 110a to 140c of FIG. 3.

A factor value of each of the plurality of inductors 511 to 514 and the capacitor 520 of FIG. 5 may be determined according to at least one of the horizontal length w11, the vertical length d11, and the line width w′11 of the floating radiator 1100. For example, an imaginary component of the factor value of each of the plurality of inductors 511 to 514 and the capacitor 520 may be determined according to at least one of the horizontal length w11, the vertical length d11, and the line width w′11 of the floating radiator 1100. For example, an imaginary component of an inductance value of each of the plurality of inductors 511 to 514 and an imaginary component of a capacitance value of the capacitor 520 may be determined according to at least one of the horizontal length w11, the vertical length d11, and the line width w′11 of the floating radiator 1100.

A direction of a second electromagnetic wave radiated from the floating radiator 1100 may be determined based on the imaginary component of the factor value of each of the plurality of inductors 511 to 514 and the capacitor 520 of FIG. 5. For example, the direction of the second electromagnetic wave radiated from the floating radiator 1100 may be determined based on at least one of the horizontal length w11, the vertical length d11, and the line width w′11 of the floating radiator 1100. At least one of the horizontal length w11, the vertical length d11, and the line width w′11 of the floating radiator 1100 may be determined such that a radiation direction of a second electromagnetic wave radiated from the floating radiator 1100 is the same as a radiation direction of a first electromagnetic wave radiated from the 1a-th antenna element 110a.

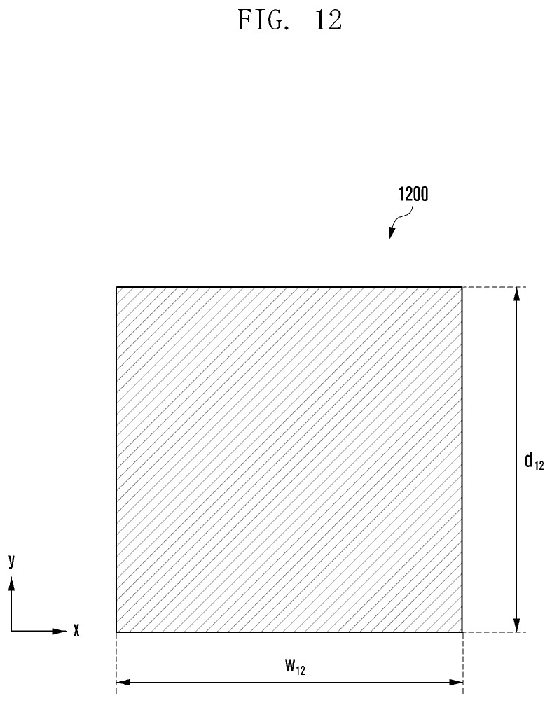

FIG. 12 is a conceptual diagram illustrating at least one floating radiator among a plurality of floating radiators of an antenna module of an electronic device, according to an embodiment of the disclosure.

Referring to FIG. 12, a floating radiator 1200 may be a rectangular patch-type radiator. The floating radiator 1200 may be the same as or similar to at least one of the plurality of floating radiators 210a to 250j of FIG. 3.

For example, a horizontal length w12 and a vertical length d12 of the floating radiator 1200 may be determined based on the magnitude of wavelength of an electromagnetic field output from the plurality of antenna elements 110a to 140c of FIG. 3.

A factor value of each of the plurality of inductors 511 to 514 and the capacitor 520 of FIG. 5 may be determined according to at least one of the horizontal length w12 and the vertical length d12 of the floating radiator 1200. For example, an imaginary component of the factor value of each of the plurality of inductors 511 to 514 and the capacitor 520 may be determined according to at least one of the horizontal length w12 and the vertical length d12 of the floating radiator 1200. For example, an imaginary component of an inductance value of each of the plurality of inductors 511 to 514 and an imaginary component of a capacitance value of the capacitor 520 may be determined according to at least one of the horizontal length w12 and the vertical length d12 of the floating radiator 1200.

A direction of a second electromagnetic wave radiated from the floating radiator 1200 may be determined based on the imaginary component of the factor value of each of the plurality of inductors 511 to 514 and the capacitor 520 of FIG. 5. For example, the direction of the second electromagnetic wave radiated from the floating radiator 1200 may be determined based on at least one of the horizontal length w12 and the vertical length d12 of the floating radiator 1200. At least one of the horizontal length w12 and the vertical length d12 of the floating radiator 1200 may be determined such that a radiation direction of a second electromagnetic wave radiated from the floating radiator 1200 is the same as a radiation direction of a first electromagnetic wave radiated from the 1a-th antenna element 110a.

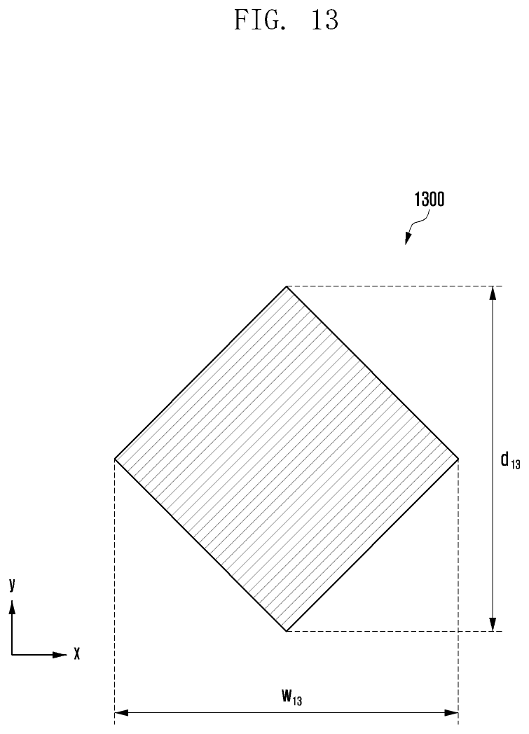

FIG. 13 is a conceptual diagram illustrating at least one floating radiator among a plurality of floating radiators of an antenna module of an electronic device, according to an embodiment of the disclosure.

Referring to FIG. 13, a floating radiator 1300 may be a patch-type radiator having a diamond shape. The floating radiator 1300 may be the same as or similar to at least one of the plurality of floating radiators 210a to 250j of FIG. 3.

For example, a horizontal length w13 and a vertical length d13 of the floating radiator 1300 may be determined based on the magnitude of wavelength of an electromagnetic field output from the plurality of antenna elements 110a to 140c of FIG. 3.

A factor value of each of the plurality of inductors 511 to 514 and the capacitor 520 of FIG. 5 may be determined according to at least one of the horizontal length w13 and the vertical length d13 of the floating radiator 1300. For example, an imaginary component of the factor value of each of the plurality of inductors 511 to 514 and the capacitor 520 may be determined according to at least one of the horizontal length w13 and the vertical length d13 of the floating radiator 1300. For example, an imaginary component of an inductance value of each of the plurality of inductors 511 to 514 and an imaginary component of a capacitance value of the capacitor 520 may be determined according to at least one of the horizontal length w13 and the vertical length d13 of the floating radiator 1300.

A phase of a second electromagnetic wave radiated from the floating radiator 1300 may be determined based on the imaginary component of the factor value of each of the plurality of inductors 511 to 514 and the capacitor 520 of FIG. 5. For example, the phase of the second electromagnetic wave radiated from the floating radiator 1300 may be determined based on at least one of the horizontal length w13 and the vertical length d13 of the floating radiator 1300. At least one of the horizontal length w13 and the vertical length d13 of the floating radiator 1300 may be determined such that a phase of a second electromagnetic wave radiated from the floating radiator 1300 is the same as a phase of a first electromagnetic wave radiated from the 1a-th antenna element 110a.

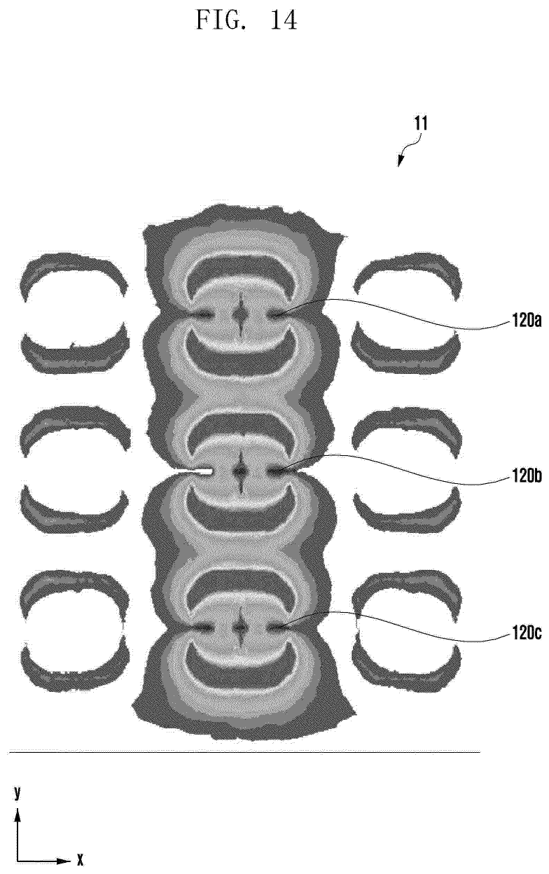

FIG. 14 is a conceptual diagram illustrating radiation characteristics of an antenna module which does not include a plurality of floating radiators in an electronic device 10, according to an embodiment of the disclosure.

Referring to FIG. 14, radiation characteristics of the antenna module 11 which does not include the plurality of floating radiators 210a to 250c in the electronic device 10 may be shown in Table 1 below.

TABLE 1

| | Type | +45(−90/90) | −45(−90/90) | V(−90/90) | H(−90/90) |
|---|---|---|---|---|---|
| Side ratio | First | 21.80/ | 20.95/ | | 28.13/ |
| [dB] | column | 21.94 | 26.35 | | 32.25 |
| | Second | 27.48/ | 22.96/ | 18.24/ | |
| | column | 22.18 | 27.44 | 17.90 | |
| Rear ratio | First | 18.05 | 18.49 | 19.06 | 22.25 |
| [dB] | column | | | | |
| | Second | 18.54 | 22.95 | 18.31 | 20.59 |
| | column | | | | |

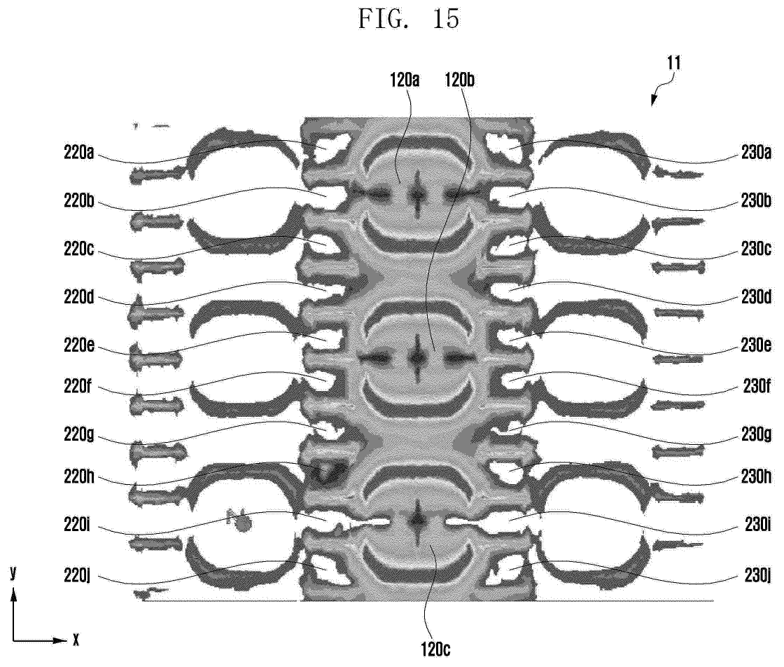

FIG. 15 is a conceptual diagram illustrating radiation characteristics of an antenna module which includes a plurality of floating radiators in an electronic device, according to an embodiment of the disclosure.

Referring to FIG. 15, due to the plurality of floating radiators 210a to 250c, a range of an electric field distributed on the surface of the antenna module 11 may be widened. The antenna module 11 may have a wide range of electric field distribution due to the plurality of floating radiators 210a to 250c. Accordingly, the width of a beam radiated from the antenna module 11 may be narrowed. For example, the antenna module 11 which includes the plurality of floating radiators 210a to 250c may have radiation characteristics as shown in Table 2 below.

TABLE 2

| | Type | +45(−90/90) | −45(−90/90) | V(−90/90) | H(−90/90) |
|---|---|---|---|---|---|
| Side ratio | First | 22.30/ | 20.39/ | | 29.50/ |
| [dB] | column | 21.86 | 24.32 | | 32.80 |
| | Second | 26.86/ | 23.84/ | 20.07/ | |
| | column | 26.14 | 27.83 | 19.81 | |
| Rear ratio | First | 21.01 | 20.39 | 18.70 | 23.42 |
| [dB] | column | | | | |
| | Second | 19.61 | 19.52 | 22.10 | 21.62 |
| | column | | | | |

Referring to the radiation characteristics in FIGS. 14 and 15 and Table 1 and Table 2, a side ratio of the antenna module 11 of the electronic device 10 which includes the plurality of floating radiators 210a to 250c may have more improved characteristics than a side ratio of the antenna module 11 of the electronic device 10 which does not include the plurality of floating radiators 210a to 250c. A rear ratio of the antenna module 11 of the electronic device 10 which includes the plurality of floating radiators 210a to 250c may have more improved characteristics than a rear ratio of the antenna module 11 of the electronic device 10 which does not include the plurality of floating radiators 210a to 250c. In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, various modifications and changes may be made thereto without departing from the scope of the disclosure. Therefore, the scope of the disclosure should not be defined as being limited to the embodiments, but should be defined by the appended claims and equivalents thereof.

The disclosure may be used in the electronics industry and the information and communications industry.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An antenna module comprising:
a board;
an antenna array including a plurality of sub-arrays which are spaced apart from a side of the board by a predetermined distance, wherein each sub-array includes antenna elements arranged in a line; and
a plurality of floating radiator arrays arranged with the plurality of sub-arrays on the board and spaced apart from the side of the board by the predetermined distance, wherein each floating radiator array includes floating radiators arranged in a line,
wherein a number of floating radiators included in the floating radiators arranged in a line is greater than a number of antenna elements included in the antenna elements arranged in a line, and
wherein current of each of the plurality of floating radiator arrays is induced by signals radiated by the antenna array.

2. The antenna module of claim 1,
wherein the antenna module comprises feeding circuitry configured to supply electrical signals to the antenna array, and
wherein the electrical signals cause the antenna array to radiate the signals.

3. The antenna module of claim 1, wherein the plurality of floating radiator arrays are arranged alternatively with the plurality of sub-arrays.

4. The antenna module of claim 1, wherein an upper side of the antenna array is spaced apart from the side of the board by the predetermined distance.

5. The antenna module of claim 1, wherein upper sides of the plurality of floating radiator arrays are spaced apart from the side of the board by the predetermined distance.

6. The antenna module of claim 1,
wherein each floating radiator of the plurality of floating radiator arrays has a capacitance value and first to fourth inductance values,
wherein the capacitance value and the first to fourth inductance values are determined according to at least one of a horizontal length and a vertical length of a corresponding floating radiator, and
wherein a phase of an electromagnetic wave radiated from the corresponding floating radiator is determined based on at least one of the capacitance value, or first to fourth inductance values.

7. The antenna module of claim 6, wherein a phase of an electromagnetic wave radiated from the corresponding floating radiator corresponds to a phase of an electromagnetic wave radiated from a corresponding antenna element adjacent to the corresponding floating radiator.

8. The antenna module of claim 1, wherein the plurality of floating radiator arrays are disposed for reducing surface waves of the antenna array induced by the signals radiated by the antenna array.

9. The antenna module of claim 1, wherein each floating radiator of the plurality of floating radiator arrays has a ring shape.

10. The antenna module of claim 1, wherein a horizontal length and a vertical length of each floating radiator corresponds to a quarter of a wavelength of each signal of the signals radiated by the antenna array.

11. An electronic device comprising:
at least one processor;
communication circuitry connected to the at least one processor; and
an antenna module connected to the communication circuitry;
wherein the antenna module comprises:
a board,
an antenna array including a plurality of sub-arrays which are spaced apart from a side of the board by a predetermined distance, wherein each sub-array includes antenna elements arranged in a line, and
a plurality of floating radiator arrays arranged with the plurality of sub-arrays on the board and spaced apart from the side of the board by the predetermined distance, wherein each floating radiator array includes floating radiators arranged in a line,
wherein a number of floating radiators included in the floating radiators arranged in a line is greater than a number of antenna elements included in the antenna elements arranged in a line, and
wherein current of each of the plurality of floating radiator arrays is induced by signals radiated by the antenna array.

12. The electronic device of claim 11,
wherein the antenna module comprises feeding circuitry configured to supply electrical signals to the antenna array, and
wherein the electrical signals cause the antenna array to radiate the signals.

13. The electronic device of claim 11, wherein the plurality of floating radiator arrays are arranged alternatively with the plurality of sub-arrays.

14. The electronic device of claim 11, wherein an upper side of the antenna array is spaced apart from the side of the board by the predetermined distance.

15. The electronic device of claim 11, wherein upper sides of the plurality of floating radiator arrays are spaced apart from the side of the board by the predetermined distance.

16. The electronic device of claim 11,
wherein each floating radiator of the plurality of floating radiator arrays has a capacitance value and first to fourth inductance values,
wherein the capacitance value and the first to fourth inductance values are determined according to at least one of a horizontal length and a vertical length of a corresponding floating radiator, and
wherein a phase of an electromagnetic wave radiated from the corresponding floating radiator is determined based on at least one of the capacitance value, or first to fourth inductance values.

17. The electronic device of claim 16, wherein a phase of an electromagnetic wave radiated from the corresponding floating radiator corresponds to a phase of an electromagnetic wave radiated from a corresponding antenna element adjacent to the corresponding floating radiator.

18. The electronic device of claim 11, wherein the plurality of floating radiator arrays are disposed for reducing surface waves of the antenna array induced by the signals radiated by the antenna array.

19. The electronic device of claim 11, wherein each floating radiator of the plurality of floating radiator arrays has a ring shape.

20. The electronic device of claim 11, wherein a horizontal length and a vertical length of each floating radiator corresponds to a quarter of a wavelength of each signal of the signals radiated by the antenna array.
